(19) United States
(12) Patent Application Publication
(10) Pub. No.: US 2006/0012575 A1
(43) Pub. Date: Jan. 19, 2006

(54) Touch sensitive active matrix display and method for touch sensing

(75) Inventors: Alan G. Knapp, Crawley (GB); Mark T. Johnson, Veldhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., Eindhoven (NL)

(21) Appl. No.: 10/538,278

(22) PCT Filed: Nov. 27, 2003
(86) PCT No.: PCT/IB03/05537

§ 371 Date: Jun. 10, 2005

(30) Foreign Application Priority Data
Dec. 12, 2002 (GB) 0229236.5

(51) Int. Cl. G09G 5/00

(52) U.S. Cl. 345/173

(57) ABSTRACT

A touch sensitive active martix display device has an array of capacitive display element pixels (16), each associated with a pixel storage capacitor (20) and a pixel transistor. One or more common electrode contacts (18a) are provided and connected to a terminal of a plurality of the display elements (16). Each common electrode contact is individually connectable to a charge measurement device (50) for measuring a flow of charge to the common electrode contact. The charge flowing through the capacitive display element can thus be measured while the pixel transistor is switched off. This flow of charge represents the transfer of charge between the pixel storage capacitor (20) and the display element (16) and results from a change in capacitance, and is therefore indicative of a touch input.

### DESCRIPTION

This invention relates to active matrix liquid crystal displays, and particularly such displays with a touch sensitive input function.

Active matrix displays typically comprise an array of pixels arranged in rows and columns. Each row of pixels shares a row conductor which connects to the gates of the thin film transistors of the pixels in the row. Each column of pixels shares a column conductor, to which pixel drive signals are provided. The signal on the row conductor determines whether the transistor is turned on or off, and when the transistor is turned on, by a high voltage pulse on the row conductor, a signal from the column conductor is allowed to pass on to an area of liquid crystal material (or other capacitive display cell), thereby altering the light transmission characteristics of the material.

FIG. 1 shows a conventional pixel configuration for an active matrix liquid crystal display. The display is arranged as an array of pixels in rows and columns. Each row of pixels shares a common row conductor 10, and each column of pixels shares a common column conductor 12. Each pixel comprises a thin film transistor 14 and a liquid crystal cell 16 arranged in series between the column conductor 12 and a common electrode 18. The transistor 14 is switched on and off by a signal provided on the row conductor 10. The row conductor 10 is thus connected to the gate 14a of each transistor 14 of the associated row of pixels. Each pixel additionally may comprise a storage capacitor 20 which is connected at one end 22 to the next row electrode, to the preceding row electrode, or to a separate capacitor electrode. The capacitance of the pixel (capacitor 20 or self-capacitance) stores a drive voltage so that a signal is maintained across the liquid crystal cell 16 even after the transistor 14 has been turned off.

In order to drive the liquid crystal cell 16 to a desired voltage to obtain a required gray level, an appropriate signal is provided on the column conductor 12 in synchronism with a row address pulse on the row conductor 10. This row address pulse turns on the thin film transistor 14, thereby allowing the column conductor 12 to charge the liquid crystal cell 16 to the desired voltage, and also to charge the storage capacitor 20 to the same voltage. At the end of the row address pulse, the transistor 14 is turned off, and the storage capacitor 20 maintains a voltage across the cell 16 when other rows are being addressed. The storage capacitor 20 reduces the effect of liquid crystal leakage and reduces the percentage variation in the pixel capacitance caused by the voltage dependency of the liquid crystal cell capacitance.

The rows are addressed sequentially so that all rows are addressed in one frame period, and refreshed in subsequent frame periods.

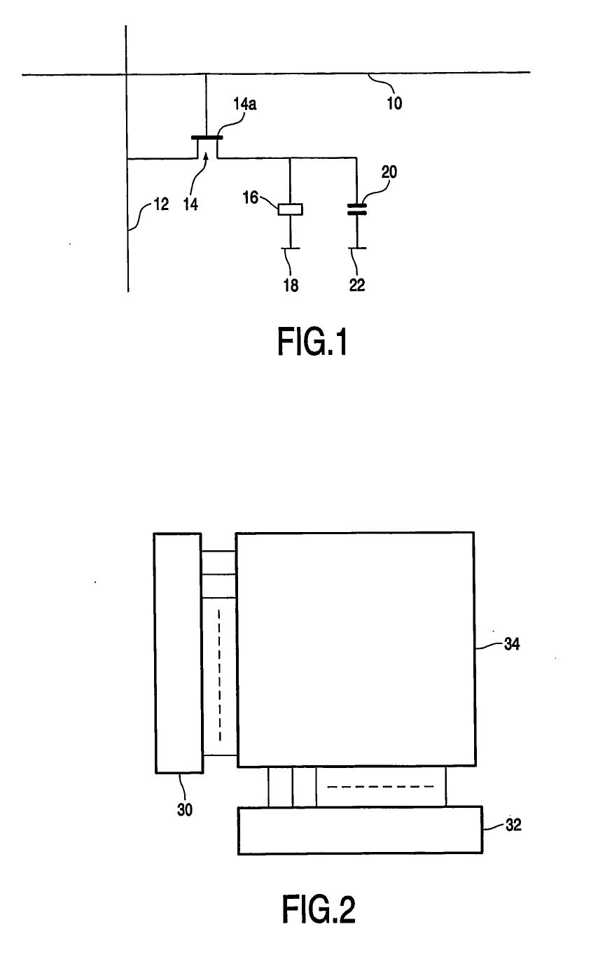

As shown in FIG. 2, the row address signals are provided by row driver circuitry 30, and the pixel drive signals are provided by column address circuitry 32, to the array 34 of display pixels.

The ability to interact with a display by using fingers (touch input) or a stylus (pen input) to allow input to the system connected to the display is a highly desirable feature and a number of methods have been developed to do this. In most cases, these methods involve the addition of extra components in front of, behind or around the edge of the display.

It has been recognised that the liquid crystal layer of a display can also be used as a pressure sensor. In particular, the application of pressure to the liquid crystal layer changes the local electrical capacitance of the layer, and this change can be used to detect the presence of a pressure input at that point. Some schemes have been proposed with simultaneous display and pressure sensing, and others have been proposed with sequential display and pressure sensing operations.

For example, JP 2000/066837 discloses a method by which the amount of charge required to recharge a pixel is measured and compared with the charge required for other pixels. In this way, a change in capacitance is detected, representative of pressure applied to the liquid crystal material of the pixel. In U.S. Pat. No. 5,777,596, the charge time of liquid crystal display elements are compared to a reference value in order to determine which elements are being touched. When using charge time or quantity as a measure of capacitance, the pixel needs to be completely discharged, and charged to a given voltage, in order to enable a comparison to be made. This inevitably disrupts the normal display operation. For example, in U.S. Pat. No. 5,777,596, a so-called “blinking line” approach is used. A blinking line progresses from the top to the bottom of the screen, during which the display elements are driven between fully discharged and charged states. Clearly this provides an undesirable image artifact. An alternative approach disclosed in U.S. Pat. No. 5,777,596 is a so-called “hot spot cursor” approach, in which a smaller area is caused to blink, and this blinking small area is dragged to the desired location. Again, the displayed image is disturbed.

According to the invention, there is provided a touch sensitive display device comprising an array of capacitive display element pixels, each display element being associated with a pixel circuit including a pixel storage capacitor, each display element being connected at a first terminal to the storage capacitor,

wherein the device further comprises one or more common electrode contacts, the or each common electrode contact being connected to a second terminal of a plurality of the display elements, and wherein each common electrode contact is individually connectable to a charge measurement means for measuring a flow of charge to the common electrode contact.

In this arrangement, the charge flowing through the capacitive display element to (or from) the second terminal can be measured. This flow of charge represents the transfer of charge between the pixel storage capacitor and the display element, resulting from a change in capacitance of the capacitive display element, and therefore indicative of a touch input. This charge measurement can be performed whilst the display pixel is displaying an image and without changing the normal display drive scheme.

There may be only one common electrode contact, which is the shared common electrode contact for all pixels of the array. In this case, touch sensing resolution is achieved by means of row conductors. However, a plurality of common electrode contacts are preferably provided, so that resolution in row and column directions can be achieved. Each common electrode contact can then be connected to a respective charge sensitive amplifier (although a multiplexer could be used to enable an amplifier to be shared). The charge sensitive amplifier preferably connects the common electrode contact to a virtual earth potential, so that the common electrode contact is held to ground. Thus, the provision of charge measurement does not affect the normal display operation as the voltages used for the display operation are preserved.

Preferably, the array of display element pixels is arranged in rows and columns, and wherein each common electrode contact is connected to the second terminals of the display elements of a plurality of adjacent columns of display elements pixels. The contacts thus provide resolution across the columns. Each row of display element pixels then shares a common row conductor, and each pixel comprises a storage capacitor connected between the display element and the row conductor of an adjacent row of display element pixels. This enables the charge flowing to the storage capacitor to be monitored by means of the row conductors, so that the combination of charge measurement for the columns and for the rows allows the touch input location to be identified.

Preferably, a plurality of groups of adjacent rows are defined with each group individually connectable to a charge measurement means for measuring a flow of charge to the group of row conductors. This means that each touch input area is defined by the crossover of a group of rows and columns, so that the sensitivity is improved.

The capacitive display elements may comprise liquid crystal display elements.

The invention also provides a method of detecting a touch input in a touch sensitive display device, the device comprising an array of capacitive display element pixels each comprising a capacitive display element and a pixel storage capacitor, the method comprising:

applying display signals to the pixels of the array, by charging the display element of each pixel to a desired voltage through a pixel transistor;

isolating each pixel by switching off the pixel transistor, and storing the voltage on the display element using the pixel storage capacitor; and

whilst the pixel is isolated, sensing the charge flowing between the storage capacitor and the capacitive display element.

The sensing of the charge flowing enables a change in capacitance of the capacitive display element to be detected, which is indicative of the display being touched.

By sensing charge flowing after the pixels have been addressed, the method avoids distortion of the displayed image to enable touch sensing to be implemented.

The sensing is preferably carried out by monitoring the charge flowing to a terminal of the capacitive display element. Preferably this terminal of a plurality of display elements is monitored, the plurality of display elements sharing a common contact and comprising a column or columns of display elements. Preferably, the charge flowing to a terminal of the pixel storage capacitor is also monitored. Preferably, the charge flowing to that terminal of a plurality of pixel storage capacitors is monitored, the plurality of pixel storage capacitors sharing a common contact and comprising the pixel storage capacitors of a row or rows of pixels.

Thus, row conductors and the common contact shared between columns of the display elements are monitored in order to enable the location of touch input to be detected.

Changing display drive levels also results in capacitance changes, and therefore charge flow. Thus, a subset of the pixels of the array may be used for touch sensing and display, the remaining pixels being used only for display. In this case, substantially static images can be provided to the subset (for example alternate rows) of pixels.

Alternatively, the display data for the subset may be repeated, and touch sensing is performed in the first or in a subsequent repetition, so that the image is then static. The subset may be different for different frames, so that the area used for touch sensing moves around the image. This enables the method to work reliably for moving images.

Examples of the invention will now be described in detail with reference to the accompanying drawings, in which:

FIG. 1 shows a known AMLCD pixel;

FIG. 2 shows a known AMLCD display which may be modified in accordance with the invention;

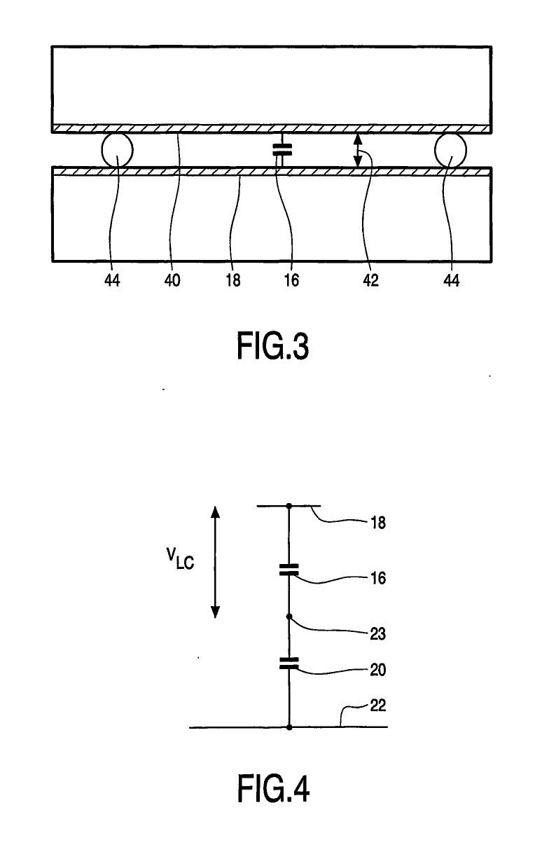

FIG. 3 is used to explain how an LC cell can be used for touch sensing;

FIG. 4 shows an equivalent circuit for an addressed pixel and is used to explain the touch sensing operation in more detail;

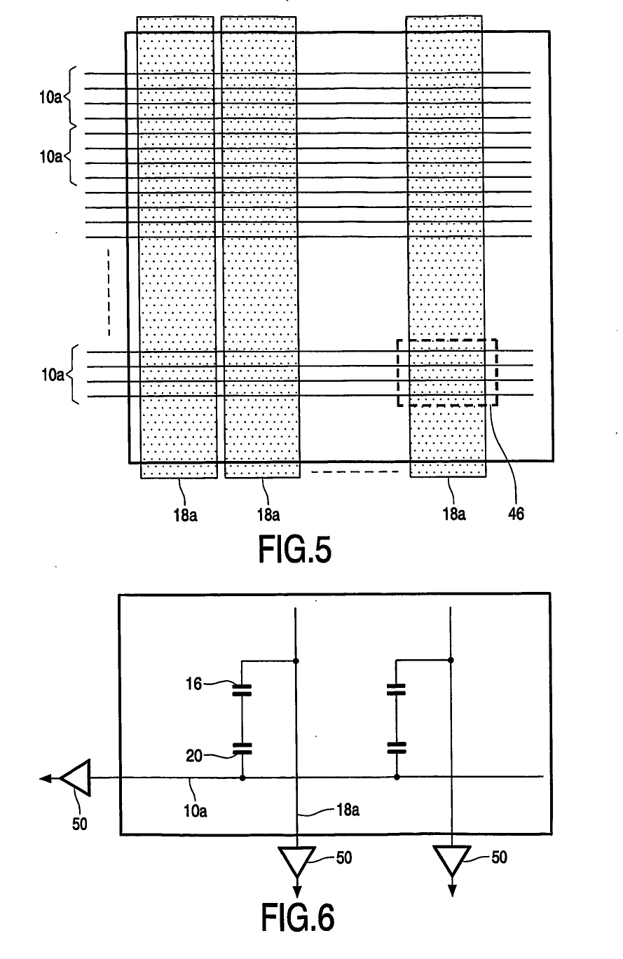

FIG. 5 shows how display electrodes are arranged in accordance with the invention; and

FIG. 6 shows a display in accordance with the invention.

It will be appreciated that the Figures are merely schematic. The same reference numbers are used throughout the Figures to denote the same, or similar, parts.

This invention provides a display and a drive method which allows the sensing of physical pressure caused by finger or a stylus on the front of an LC display without adding extra components to the display substrate. This is achieved by using components already present in the display to do the sensing and connecting them to additional electronic circuits. Furthermore, image distortion is avoided or kept to a minimum, and simultaneous display and sensing is obtained.

The basis of the system is to detect the change in capacitance of the LC pixels in the display caused by pressure on the front glass (or plastic). FIG. 3 shows a schematic cross-section of an active matrix liquid crystal display (AMLCD). The pixel capacitance is defined by the capacitance between the pixel electrode 40 and the common electrode 18 and is proportional to the reciprocal of the cell gap, 42. If pressure is applied, the substrates forming the LC cell can deform as can the spacer balls 44, causing a reduction in the cell gap, 42, and hence an increase in the pixel capacitance.

The system of the invention senses the touch input during the period when the TFT 14 of the pixel circuit (FIG. 1) is turned off, isolating the pixel and storage capacitors from the display columns 12. In this situation the equivalent circuit of the pixel is as shown in FIG. 4. The node 23 is a node of the pixel circuit which is supplied with a pixel drive voltage by the transistor 14. This circuit will be referred to further below.

FIG. 5 shows how the existing display components are used to provide the touch sensing function.

The common electrode 18 is divided into separate contacts 18a. Each electrode contact 18a is connected to the second terminal of the display elements of a number of columns of pixels. Each common electrode contact 18a is individually connectable to a charge sensitive amplifier for measuring a flow of charge to the common electrode contact 18a. In this way, the charge flowing through the LC cell 16 to the second terminal (which is no longer common to all pixels) can be measured. This flow of charge represents the transfer of charge between the storage capacitor 20 and the LC cell 16, and is indicative of a touch input.

The rows are also arranged in groups 10a, so that touch sensitive input areas 46 are defined by the crossover of a group 10a of rows and a group of columns sharing the common electrode contact 18a.

If it is assumed that the common electrode is split into S segments and the row conductors to which the storage capacitors are attached are divided into R groups 10a, this allows touch to be sensed in R×S areas of the display. Increasing R and/or S increases the resolution of the sensing but means that the size of the charge sensed will be smaller. R and S can therefore be selected according to the demands of the application.

As there is a voltage V_{LC} typically in the range 2V-6V across the LC cell, an increase in the capacitance will cause a flow of charge into the pixel from the common electrode 18, and from the connection to the storage capacitor 20. This connection is an adjacent row in the pixel circuit of FIG. 1, although it may be a separate capacitor line.

In the simple arrangement illustrated in FIG. 4, if the capacitance C_{LC} of the LC cell 16 is changed by an amount ΔC then, provided ΔC is small compared to C_{LC} and the storage capacitance Cₛ (of capacitor 20), the amount of charge flow, ΔQ, required to hold the voltage across Cₛ and C_{LC} in series is given by:

$$Δ Q = \frac{ΔC \cdot {V}_{LC} \cdot {C}_{S}}{{C}_{LC} + {C}_{S}}$$

The approximate magnitude of the charge displaced by touching the display is easy to determine from this formula. For a typical AMLCD, Cₛ is approximately equal to C_{LC}. The value of ΔC, assuming standard cell thickness and dielectric constant for the LC material and a 5% change in cell gap, is 44 pf/cm². If V_{LC}=4V then ΔQ=88 pC/cm². If around 0.5 cm² of the area of the display is distorted then the charge displaced will be around 45 pC which can easily be detected by standard charge amplifiers connected as described below.

FIG. 6 shows a schematic diagram for a method of sensing the charge displacement produced by the distortion of the LC cell gap. Each group 10a of rows and each common electrode contact 18a is connected to a virtual earth charge sensitive amplifier 50. A row group 10a and a common electrode contact 18a are each illustrated as a single line in FIG. 6 for simplicity. When an area of the display is touched, the charge will flow in one or more of the common electrode contacts 18a and in one or more of the row groups 10a. These charge flows will be sensed by the charge sensitive amplifiers 50 connected to those row groups and common electrode contacts and will produce a change in the signal on the output of the amplifiers. By continuously monitoring the outputs of the S common electrode contacts and R row groups, the signal resulting from touching the display may be sensed and the position and area being touched can be deduced by determining which amplifiers have produced the signal. The charge sensitive amplifiers are virtual earth amplifiers, so that the effects of cross coupling capacitances between the common electrode contacts or the row groups in other parts of the display are minimised.

The amplifiers also hold the row and column conductors to ground potential during the touch sensing operation, which is compatible with the normal display operation of the device.

A simple version of this system can be made with a single common electrode contact (S=1). This cannot detect horizontal position but can detect vertical position which, for many actions like selecting from a standard menu in which the items are all at different vertical positions, gives all the information needed by the application.

In a standard LC display, changes in pixel capacitance can be induced by changes in drive level on the pixels, since the LC dielectric constant and hence cell capacitance is drive-level dependant. This means that changing images can induce similar signals to those produced by a touch input and could cause spurious touch detection signals to be generated.

For a static image there is no issue, and the sensing is straightforward. Since, in the applications for which touch input is required, the images (for example of menus, key pads etc.) are usually static, then the effect of changing images is not an issue. There is also no problem if only a small fraction of the pixels in the area of the row blocks or common electrode segments change such that the capacitance changes induced by the image changes are small compared to those induced by touch pressure. Furthermore it is possible to allow larger changes in image if some cause capacitance change in one direction and some in the other, resulting in cancellation and zero or very small change in overall capacitance. For example, an image with blocks flashing black to white and others of equal area under the same segments flashing white to black (i.e. in antiphase) will not cause a problem as the total capacitance will be constant.

It is, however, possible to adapt the use of the display to allow for moving images to be displayed whilst still enabling touch sensing.

The touch sensing is still carried out whilst the pixel is isolated, again sensing the charge flowing between the storage capacitor and the capacitive display element. However, a subset of the pixels of the array may be used for touch sensing and display, the remaining pixels being used only for display. In this way, substantially static images can be provided to the subset of pixels. For example, only every other (or every nₜₕ) connection in the horizontal group of rows is used for sensing and the moving parts of the image are only directed onto the rows which are not connected to the sense amplifiers. As a result, there is no capacitance change in the sensing rows. This is more difficult to apply in the vertical direction and may only be applicable to images where only selection of a vertical position is needed (as described above for the example where S=1).

Alternatively, the display data for the subset may be repeated, and touch sensing is performed during the period when the image data is repeated, so that the image is then static. Thus, the information on one (or more) of the sensing blocks can be intentionally repeated for 2 or more frames to allow sensing of those blocks only. By shifting the position of the active sensing blocks through the display from frame to frame, the entire display could be scanned for touch input. The perceptive impact of this would be minimal.

In the example above, a terminal of each storage capacitor is connected to the following row. Instead, additional capacitor contact row conductors may be provided, and these will then be coupled to the charge sensitive amplifiers.

In this description, where the terms “row” and “column” are used, this is purely arbitrary, and the display may be rotated by 90 degrees. Thus, these terms are not to be construed as limiting, and more significant is that conductors cross (not necessarily at 90 degrees) in order to define unique touch sensing areas.

The preferred implementation is for an LC display, but other capacitive display elements, which display a change in capacitance in response to applied pressure, could also be contemplated.

As explained above, the invention enables a normal drive scheme to be used for the display, although modifications are possible to ensure that the touch sensing is performed only in areas of the display where there is no image change. The invention simply requires the addition of charge sensitive amplifiers, either in the row and column drivers (30,32 of FIG. 2) or in additional dedicated circuitry. The invention also requires patterning of the common electrode layer—if more than one common electrode contact is desired.

Various other modifications will be apparent to those skilled in the art.

1. A touch sensitive display device comprising an array of capacitive display element pixels, each display element being associated with a pixel circuit including a pixel storage capacitor, each display element being connected at a first terminal to the storage capacitor,
wherein the device further comprises one or more common electrode contacts, the or each common electrode contact being connected to a second terminal of a plurality of the display elements, and wherein each common electrode contact is individually connectable to a charge measurement means for measuring a flow of charge to the common electrode contact.

2. A device as claimed in claim 1, wherein a plurality of common electrode contacts are provided.

3. A device as claimed in claim 2, wherein each common electrode contact is connected to a respective charge measurement means.

4. A device as claimed in claim 1, wherein the or each charge measurement means comprises a charge sensitive amplifier.

5. A device as claimed in claim 4, wherein each charge sensitive amplifier connects the common electrode contact to a virtual earth potential.

6. A device as claimed in claim 1, wherein the array of display element pixels is arranged in rows and columns, and wherein each common electrode contact is connected to the second terminals of the display elements of a plurality of adjacent columns of display element pixels.

7. A device as claimed in claim 6, wherein each row of display element pixels shares a common row conductor for providing a pixel address signal, and wherein the storage capacitor of each pixel is connected between the display element and the row conductor of an adjacent row of display element pixels.

8. A device as claimed in claim 6, wherein each row of display element pixels shares a common capacitor row conductor, and the storage capacitor of each pixel is connected between the display element and the capacitor row conductor.

9. A device as claimed in claim 7, wherein a plurality of groups of adjacent rows are defined with each group individually connectable to a charge measurement means for measuring a flow of charge to the group of row conductors.

10. A device as claimed in claim 1, wherein each pixel circuit comprises a transistor which is addressed by a signal on a row conductor associated with a row of display element pixels, and which provides a signal from a column conductor associated with a column of display element pixels to the display element.

11. A device as claimed in claim 1, wherein the capacitive display elements comprise liquid crystal display elements.

12. A method of detecting a touch input in a touch sensitive display device, the device comprising an array of capacitive display element pixels each comprising a capacitive display element and a pixel storage capacitor, the method comprising:
applying display signals to the pixels of the array, by charging the display element of each pixel to a desired voltage through a pixel transistor;
isolating each pixel by switching off the pixel transistor, and storing the voltage on the display element using the pixel storage capacitor; and
whilst the pixel is isolated, sensing the charge flowing between the storage capacitor and the capacitive display element.

13. A method as claimed in claim 12, wherein the sensing is carried out by monitoring the charge flowing to a terminal of the capacitive display element.

14. A method as claimed in claim 13, wherein the charge flowing to a terminal of a plurality of display elements is monitored, the plurality of display elements sharing a common contact and comprising a column or columns of display elements.

15. A method as claimed in claim 14, wherein the sensing is carried out by also monitoring the charge flowing to a terminal of the pixel storage capacitor.

16. A method as claimed in claim 15, wherein the charge flowing to a terminal of a plurality of pixel storage capacitors is monitored, the plurality of pixel storage capacitors sharing a common contact and comprising the pixel storage capacitors of a row or rows of pixels.

17. A method as claimed in claim 12, wherein a subset of the pixels of the array are used for touch sensing and display, the remaining pixels being used only for display.

18. A method as claimed in claim 17, wherein substantially static images are provided to the subset of pixels.

19. A method as claimed inclaim 17, wherein the subset comprises a plurality of rows of pixels.

20. A method as claimed in claim 17, wherein the display data for the subset is repeated, and touch sensing is performed in the first or in a subsequent repetition.

21. A method as claimed in claim 20, wherein the subset is different for different frames.
